(19) United States
(12) Patent Application Publication
(10) Pub. No.: US 2025/0168764 A1
(43) Pub. Date: May 22, 2025

(54) SCHEDULING DATA RADIO BEARER IN NETWORK ENERGY SAVING MODE

(71) Applicant: Lenovo (Singapore) Pte. Limited, Singapore (SG)

(72) Inventors: Tapisha Soni, Munich (DE); Karthikeyan Ganesan, Kronberg Im Taunus (DE); Ravi Kuchibhotla, Chicago, IL (US)

(73) Assignee: Lenovo (Singapore) Pte. Limited, Singapore (SG)

(21) Appl. No.: 18/951,390

(22) Filed: Nov. 18, 2024

Related U.S. Application Data
(60) Provisional application No. 63/600,713, filed on Nov. 19, 2023.

(51) Int. Cl. H04W 52/02; H04W 72/0457; H04W 72/1268; H04W 72/566; H04W 76/28

(52) U.S. Cl. CPC H04W 52/0203; H04W 72/0457; H04W 72/1268; H04W 72/566; H04W 76/28

(57) ABSTRACT

Various aspects of the present disclosure relate to scheduling data radio bearer (DRB) in network energy saving (NES) mode. An apparatus, such as a network equipment (NE), transmits, to a user equipment (UE), a mapping of NES flows to a DRB. The NE configures the DRB based at least in part on an NES class, and configures one or more bandwidth parts (BWPs) according to at least one NES configuration of the NES class. The NE configures scheduling restrictions on mapping uplink logical channels according to an NES DRB configuration, and associates the DRB to a BWP of the one or more BWPs. The NE transmits, to the UE, mapping information for the NES DRB configuration to the one or more BWPs. The UE receives, from the NE, the mapping of the NES flows to the DRB, and receives the mapping information for the NES DRB configuration to the BWPs.

### RELATED APPLICATION

This application claims priority to U.S. Provisional Application Ser. No. 63/600,713 filed Nov. 19, 2023 entitled “Scheduling Data Radio Bearer in Network Energy Saving Mode,” the disclosure of which is incorporated by reference herein in its entirety.

### TECHNICAL FIELD

The present disclosure relates to wireless communications, and more specifically to network energy saving (NES) and data radio bearer (DRB) scheduling.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, emissions and energy consumption from different elements of the system adversely contribute to the climate, and the operating expenses to run telecommunication services are immense. The increasing use of mobile data traffic will only continue to increase, combined with the rising costs of spectrum, capital investment, and ongoing RAN maintenance and upgrades, energy-saving measures in network operations are needed.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive, from a NE, a mapping of NES flows to a DRB, the DRB configured at a cell based at least in part on an NES class. The UE receives, from the NE, mapping information for an NES DRB configuration to one or more bandwidth parts (BWPs), the one or more BWPs configured according to at least one NES configuration of the NES class.

In some implementations of the method and apparatuses described herein, the UE aligns a UE connected-mode discontinuous reception (C-DRX) with a BWP discontinuous transmission and discontinuous reception (DTX/DRX) and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with a DTX/DRX configuration. The UE receives the DTX/DRX configuration as part of a group-common signaling of BWP. The UE performs logical channel scheduling as per NES priorities assigned based on the NES DRB configuration when transmitting uplink DRB.

Some implementations of the method and apparatuses described herein may further include a processor for wireless communication to receive, from a NE, a mapping of NES flows to a DRB, the DRB configured at a cell based at least in part on an NES class. The processor receives, from the NE, mapping information for an NES DRB configuration to one or more BWPs, the one or more BWPs configured according to at least one NES configuration of the NES class.

In some implementations of the method and apparatuses described herein, the processor aligns a UE C-DRX with a BWP DTX/DRX and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with DTX/DRX configuration. The processor receives the DTX/DRX configuration as part of a group-common signaling of BWP. The processor performs logical channel scheduling as per NES priorities assigned based on the NES DRB configuration when transmitting uplink DRB.

Some implementations of the method and apparatuses described herein may further include a method performed by a UE, the method including: receiving, from a NE, a mapping of NES flows to a DRB, the DRB configured at a cell based at least in part on an NES class; and receiving, from the NE, mapping information for an NES DRB configuration to one or more BWPs, the one or more BWPs configured according to at least one NES configuration of the NES class.

In some implementations of the method and apparatuses described herein, the method further comprising causing the UE to align a UE C-DRX with a BWP DTX/DRX and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with a DTX/DRX configuration. The method further comprising receiving the DTX/DRX configuration as part of a group-common signaling of BWP. The method further comprising performing logical channel scheduling as per NES priorities assigned based on the NES DRB configuration when transmitting uplink DRB.

Some implementations of the method and apparatuses described herein may further include an NE for wireless communication to transmit, to a UE, a mapping of NES flows to a DRB. The NE configures the DRB based at least in part on an NES class, and configures one or more BWPs according to at least one NES configuration of the NES class. The NE configures scheduling restrictions on mapping uplink logical channels according to an NES DRB configuration, and associates the DRB to a BWP of the one or more BWPs. The NE transmits, to the UE, mapping information for the NES DRB configuration to the one or more BWPs.

In some implementations of the method and apparatuses described herein, the NE determines the mapping of the NES flows to the DRB in accordance with the NES class. The NE configures the one or more BWPs comprising at least one of a cell-specific BWP, a group common BWP, or an NES-specific BWP associated with a DTX/DRX configuration. The NE determines the BWP that is associated with the DRB based at least in part on the NES class that is associated to the DRB. A group common signaling of a BWP configuration includes a corresponding NES DTX/DRX configuration of the BWP. The NE configures a UE C-DRX to partially overlap an on-duration of the BWP that is associated with the DRB and periodicities are an integer multiple. The NE configures a UE C-DRX so that a periodicity of the NES DTX/DRX configured for the BWP that is associated with the DRB is an integer multiple of the UE C-DRX. The NE configures an NES DTX/DRX configured for the BWP that is associated with a DRB periodicity to be an integer multiple of the UE C-DRX. The NE configures an alignment of a UE C-DRX with a BWP DTX/DRX and with a cell DTX/DRX of a cell enabling a partial overlap during an on-duration.

Some implementations of the method and apparatuses described herein may further include a method performed by an NE, the method including: transmitting, to a UE, a mapping of NES flows to a DRB; configuring the DRB based at least in part on an NES class; configuring one or more BWPs according to at least one NES configuration of the NES class; configuring scheduling restrictions on mapping uplink logical channels according to an NES DRB configuration; associating the DRB to a BWP of the one or more BWPs; and transmitting, to the UE, mapping information for the NES DRB configuration to the one or more BWPs.

In some implementations of the method and apparatuses described herein, the method further comprising determining the mapping of the NES flows to the DRB in accordance with the NES class. The method further comprising configuring the one or more BWPs comprising at least one of a cell-specific BWP, a group common BWP, or an NES-specific BWP associated with a DTX/DRX configuration. The method further comprising determining the BWP that is associated with the DRB based at least in part on the NES class that is associated to the DRB. A group common signaling of a BWP configuration includes a corresponding NES DTX/DRX configuration of the BWP. The method further comprising configuring a UE C-DRX to partially overlap an on-duration of the BWP that is associated with the DRB and periodicities are an integer multiple. The method further comprising configuring a UE C-DRX so that a periodicity of the NES DTX/DRX configured for the BWP that is associated with the DRB is an integer multiple of the UE C-DRX. The method further comprising configuring an NES DTX/DRX configured for the BWP that is associated with a DRB periodicity to be an integer multiple of the UE C-DRX. The method further comprising configuring an alignment of a UE C-DRX with a BWP DTX/DRX and with a cell DTX/DRX of a cell enabling a partial overlap during an on-duration.

### BRIEF DESCRIPTION OF THE DRAWINGS

FIG. 1 illustrates an example of a wireless communications system in accordance with aspects of the present disclosure.

FIG. 2 illustrates an example of an NES-QOS framework, in accordance with aspects of the present disclosure.

FIG. 3 illustrates an example of an association of an NES-QoS bearer to BWP, in accordance with aspects of the present disclosure.

FIG. 4 illustrates an example BWP baseline (alternative-A), in accordance with aspects of the present disclosure.

FIG. 5 further illustrates an example of BWPs (alternative A: option A-1), in accordance with aspects of the present disclosure.

FIG. 6 illustrates an example of BWPs (alternative A: option A-2), in accordance with aspects of the present disclosure.

FIG. 7 illustrates an example BWP baseline (alternative-B), in accordance with aspects of the present disclosure.

FIG. 8 illustrates an example of BWPs (alternative B: option B-1), in accordance with aspects of the present disclosure.

FIG. 9 illustrates an example of BWPs (alternative B: option B-2), in accordance with aspects of the present disclosure.

FIG. 10 illustrates an example alignment of a UE C-DRX configuration with BWP and a cell DTX/DRX, in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrates a flowchart of a method performed by a UE in accordance with aspects of the present disclosure.

FIG. 15 illustrates a flowchart of a method performed by a NE in accordance with aspects of the present disclosure.

### DETAILED DESCRIPTION

A wireless communications system includes a great many number of components, devices, services, and equipment, many of which contribute to rising network costs and operational expenses. Additionally, the emissions and energy consumption from the many different network elements adversely contribute to the climate. The increasing use of mobile data traffic will only continue to increase, combined with the rising costs of spectrum, capital investment, and ongoing RAN maintenance and upgrades, energy-saving measures in network operations are needed. In particular, new communications use cases and the adoption of mm-Wave will require more sites and antennas. Although this lends to the prospect of a more efficient network, the result will be an increase in emissions without active intervention. As 5G becomes pervasive across industries and geographical areas, handling more advanced services and applications requiring very high data rates, networks are becoming denser, using more antennas, larger bandwidths, and more frequency bands. Implementations of NES can help to control the environmental impact of expanding 5G.

In a wireless communications system, most of the energy consumption is due to the radio access network and in particular, from the active antenna unit (AAU), with data centers and fiber transport accounting for a smaller share of the energy consumption. The power consumption of radio access can be split into two parts, a dynamic part that only consumes power when data transmission and/or reception is ongoing, and a static part during which power is consumed all of the time to maintain the necessary operation of the radio access devices, even when the data transmission and/or reception is not on-going. Power savings techniques are therefore needed, particularly with reference to base stations, for NES and to achieve more efficient operation dynamically and/or semi-statically, with a finer granularity adaptation of transmissions and/or receptions in one or more network energy saving techniques in time, frequency, spatial, and power domains, as well as support and feedback from UEs, potential UE assistance information, and an information exchange and coordination over network interfaces. Any potential network energy consumption gains also need to take into account the impact on network and UE performance by looking at key performance indicators (KPIs) such as spectral efficiency, capacity, user perceived throughput (UPT), latency, UE power consumption, complexity, handover performance, call drop rate, initial access performance, service level agreements (SLA) assurance related KPIs, etc.

Standardized NES capability can improve energy savings, as well as importantly serve the UEs without compromising performance. The diverse use cases from industry verticals lead to different traffic models and service QoS. It may be essential to conserve maximum network energy while fulfilling the stringent QOS requirements of these diverse service categories. Additionally, the traffic pattern can be expected to change with the type of use case and/or network scenario. Therefore, a tradeoff in energy savings and the demanded KPIs is likely to occur, such as for example, a cell benefiting from maximum energy saving cannot satisfy latency-critical service requirements of sub-millisecond end-to-end latency for multiple UEs. Such degradation in QoS is intolerable for use cases like augmented reality and/or virtual reality (AR/VR), haptic feedback, autonomous vehicles, mission-critical communication, mobile robots, etc. Hence, an adaptive and robust NES mechanism is implemented to attain an optimal balance.

Conventionally, an NES configuration in an NES mode is limited to the cell level. The existing solutions do not consider network energy saving awareness in radio bearer configuration. Further, BWPs are not adapted to the NES mode and/or requirement. One possible solution relevant to BWP framework uses the default BWP. For a serving cell, the network may configure the UE with a BWP inactivity timer, and the expiration of this timer indicates that the UE has a period of no scheduled transmission and reception on the currently active BWP. Thus, the UE can switch its active BWP to a default BWP to save power. However, the conventional solutions lack flexibility and adaptability for diverse energy saving requirements when provisioned to or determined by the network.

Aspects of the disclosure are directed to techniques to mitigate the tradeoff in energy savings and user performance by incorporating QoS awareness in energy saving mode. This disclosure introduces data radio bearer optimized for energy saving and enabling energy aware scheduling by extending the bandwidth partitioning mechanism for NES mode. Further, aspects of the disclosure are directed to NES-specific data radio bearers (NES-QOS bearers) and the mapping of an NES class to different data radio bearers using NES-DRB mapping rules, including reflective mapping or explicit configuration. The NES radio bearers may provide differentiated energy saving configuration to UEs by mapping such radio bearers to same or different BWPs in a carrier. This disclosure also describes a BWP framework for an NES solution, where BWPs are optimized with certain energy saving configurations, such as a BWP-specific DTX/DRX configuration. A radio resource configuration is mapped to one of the multiple BWPs of a serving cell to guarantee corresponding NES class with each BWP. This disclosure also describes an alignment of UE C-DRX configuration as per the NES (DTX/DRX) configuration of the active BWP and the Cell DTX/DRX configuration. Additionally, an enhancement to logical channel mapping is described, where the priority is set taking into account the energy saving requirement associated to respective data radio bearers.

In aspects of this disclosure, techniques are described to map NES flows to data radio bearers, and related procedures. An energy-saving awareness is introduced in the radio bearer framework and the bandwidth partitioning framework. Conventionally, NES configuration in NES mode is limited to cell level, whereas the proposed solution enables a BWP specific NES (DTX/DRX) configuration and its respective association to radio bearers. This provides a flexibility and further granularity to configure an energy saving mode, thus improving energy savings. The described techniques introduce a new type of radio bearers configured to support certain energy saving while fulfilling the QoS requirement. It extends the BWP framework with energy saving awareness and associates the corresponding radio bearers to the respective BWP. This enables configuration of a cell specific BWP, a group common bandwidth part, and/or a bandwidth part specific NES (DTX/DRX) configuration. For a serving cell, the network may configure the UE with a BWP inactivity timer, and the expiration of this timer indicates that the UE has a period of no scheduled transmission and reception on the currently active BWP. Thus, the UE can switch its active BWP to a default BWP to save power. Additionally, a BWP framework for an NES solution can be implemented, where BWPs are optimized with certain energy saving configurations, such as a BWP-specific DTX/DRX configuration. A radio resource configuration is mapped to one of the multiple BWPs of a serving cell to guarantee a corresponding NES class with each BWP. An alignment of a UE C-DRX configuration as per the NES (DTX/DRX) configuration of the active BWP and the cell DTX/DRX configuration can be implemented. In addition, an enhancement to logical channel prioritization is described, where the priority is set considering the energy saving requirement.

Aspects of the present disclosure are described in the context of a wireless communications system for scheduling DRB in NES mode.

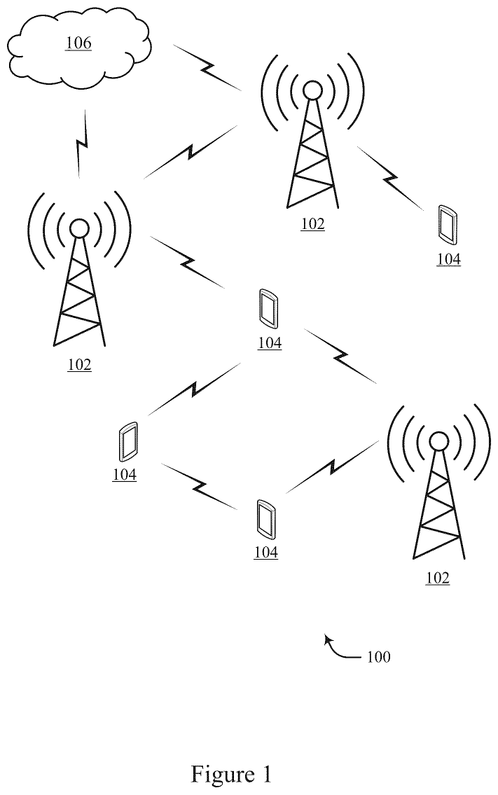

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station, gNB) transmits, to a UE 104, a mapping of NES flows to a DRB. The NE 102 configures the DRB based at least in part on an NES class, and configures one or more BWPs according to at least one NES configuration of the NES class. The NE 102 also configures scheduling restrictions on mapping uplink logical channels according to an NES DRB configuration, and associates the DRB to a BWP of the one or more BWPs. The NE 102 transmits, to the UE 104, mapping information for the NES DRB configuration to the one or more BWPs. The UE 104 receives, from the NE 102 as a cell, the mapping of the NES flows to the DRB, where the DRB is configured at the cell based at least in part on the NES class. The UE 104 receives, from the NE 102, the mapping information for the NES DRB configuration to the one or more BWPs, the one or more BWPs configured according to the NES configuration of the NES class.

A technique to improve network energy savings in time domain is cell DTX/DRX, which is applicable to UEs in a RRC connected state. A periodic cell DTX/DRX (i.e., active, and non-active periods) can be configured by gNB via UE-specific RRC signaling per serving cell, and cell DTX/DRX can also be configured and operated together. At least the following parameters can be configured per cell DTX/DRX configuration, including periodicity, start slot/offset, and on duration. UE behavior is a focus when, at any point in time, the cell activates a single DTX/DRX configuration. It is up to network whether legacy UEs in an idle mode can access cells with cell DTX/DRX and the network should be able to allow NES-capable UEs to camp on the NES cell. The cell DTX/DRX mode can be activated or deactivated via dynamic L1/L2 signaling and UE-specific RRC signaling. Both UE specific and common L1/L2 signaling can be considered for activating and deactivating the cell DTX/DRX mode. As considered, the network can configure NES capable UEs to (de) prioritize NES cells, with a mechanism such as can be considered for both frequency and cell levels cell selection or reselection (de) prioritization. Separate camping restrictions for NES-capable and non-NES UEs can also be defined.

The main motivation behind standardizing NES capability is to improve the energy savings as well as to serve the users without compromising performance. The diverse use cases from industry verticals lead to different traffic models and service QoS. It is essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur (e.g., a cell benefiting from maximum energy saving cannot satisfy latency-critical service requirements of sub-millisecond end-to-end latency for multiple UEs). Such degradation in QoS is intolerable for use cases like AR/VR, haptic feedback, autonomous vehicles, mission-critical communication, mobile robots, etc. Hence, an adaptive and robust NES mechanism is crucial to attain an optimal balance.

With reference to bandwidth partitioning, for each serving cell, the network configures at least an initial downlink bandwidth part and one (if the serving cell is configured with an uplink) or two (if using supplementary uplink (SUL)) initial uplink bandwidth parts. Furthermore, the network may configure additional uplink and downlink bandwidth parts for a serving cell. The uplink and downlink bandwidth part configurations are divided into common and dedicated parameters.

For downlink (DL), a UE is configured for operation in BWPs of a serving cell, where the BWPs are configured by higher layers for the serving cell as a set of at most four BWPs for receptions by the UE (DL BWP set) in a DL bandwidth by parameter BWP-Downlink or by parameter initialDownlinkBWP with a set of parameters configured by BWPDownlinkCommon and BWP-DownlinkDedicated. If a UE is not provided the parameter initialDownlinkBWP, an initial DL BWP is defined by a location and number of contiguous physical resource blocks (PRBs), starting from a PRB with the lowest index and ending at a PRB with the highest index among PRBs of a control resource set (CORESET) for Type0-physical downlink control channel (PDCCH) common search space (CSS) set, and a subcarrier spacing (SCS) and a cyclic prefix for PDCCH reception in the CORESET for Type0-PDCCH CSS set; otherwise, the initial DL BWP is provided by the parameter initialDownlinkBWP. If a UE has a dedicated BWP configuration, the UE can be provided by firstActiveDownlinkBWP-Id, a first active DL BWP for receptions.

For uplink (UL), a set of at most four BWPs for transmissions by the UE (UL BWP set) in an UL bandwidth by parameter BWP-Uplink or by parameter initialUplinkBWP with a set of parameters configured by BWP-UplinkCommon and BWP-UplinkDedicated. For operation on the primary cell or on a secondary cell, a UE is provided an initial UL BWP by the parameter initialUplinkBWP. If the UE is configured with a supplementary UL carrier, the UE can be provided an initial UL BWP on the supplementary UL carrier by initialUplinkBWP. If a UE has a dedicated BWP configuration, the UE can be provided by firstActiveUplinkBWP-Id, a first active UL BWP for transmissions on a carrier of the primary cell.

There are two possible ways to configure BWP #0 (i.e., the initial BWP) for a UE. First, configure BWP-DownlinkCommon and BWP-UplinkCommon in ServingCellConfigCommon, but do not configure dedicated configurations in BWP-DownlinkDedicated or BWP-UplinkDedicated in ServingCellConfig. Second, configure both BWP-DownlinkCommon and BWP-UplinkCommon in ServingCellConfigCommon. initialDownlinkBWP. The dedicated (UE-specific) configuration for the initial downlink bandwidth-part (i.e., DL BWP #0). If any of the optional IEs are configured within this IE, the UE considers the BWP #0 to be an RRC configured BWP (from the UE capability viewpoint). Otherwise, the UE does not consider the BWP #0 as an RRC configured BWP (from the UE capability viewpoint). The network always configures the UE with a value for this field if no other BWPs are configured.

With reference to a default BWP, for a serving cell, the network can configure the UE with a BWP inactivity timer. The expiration of this timer may, for example, indicate that the UE has no scheduled transmission and reception for a period of time on the currently active BWP. Thus, the UE can switch its active BWP to a default BWP to save power. The default DL BWP can be configured. If not configured, the UE uses the initial DL BWP as the default DL BWP. In an unpaired spectrum, when the UE switches its active DL BWP to the default DL BWP, the active UL BWP is switched accordingly since the BWP switching for time division duplex (TDD) is common for both DL and UL. Bandwidth part operation, BWP selection (or BWP switching) can be accomplished several different ways, such as by dedicated RRC signaling; by over PDCCH channel downlink control information (DCI)-DCI 0_1 (UL Grant) and DCI 1_0 (DL Scheduling); by BWP-inactivityTimer-ServingCellConfig.bwp-InactivityTimer; and/or by a medium access control (MAC) control element (CE).

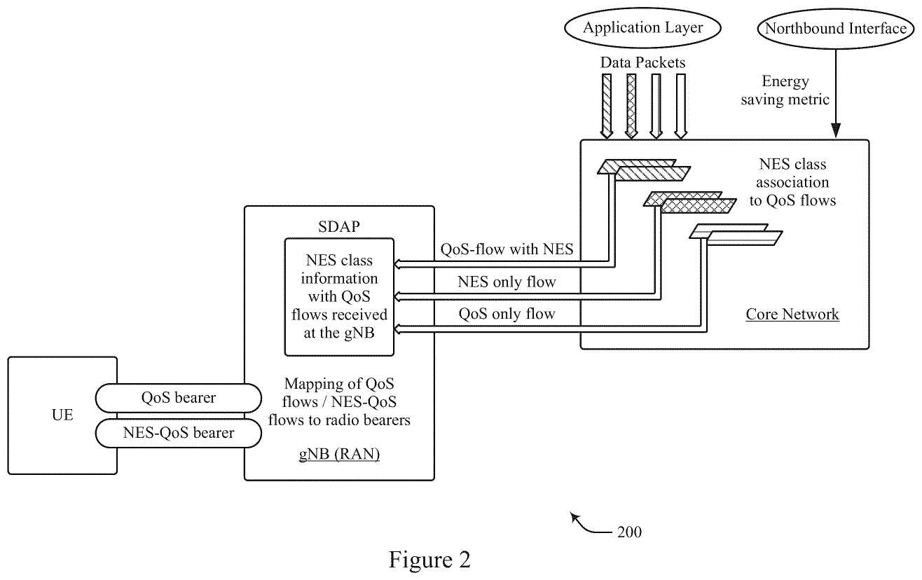

FIG. 2 illustrates an example of an NES-QOS framework 200, in accordance with aspects of the present disclosure. Aspects of the techniques described herein can be implemented to mitigate the tradeoff in energy savings and user performance by incorporating QoS awareness in energy saving mode. This disclosure introduces radio bearer optimized for energy saving and enabling energy aware scheduling by extending the bandwidth partitioning mechanism for NES mode. As defined herein for an NES-QoS flow, it is the QoS flow that contains the energy saving awareness along with a QoS requirement (i.e., a requirement for energy saving exists). Thus, NES and QoS both hold priority. For NES flow, it is the QoS flow that contains the energy saving requirements with best-effort QoS. Thus, NES holds priority. For QoS flow, the QoS flow does not contain any energy saving awareness. Thus, QoS holds priority. Hereafter, NES-relevant flows that contain an energy saving requirement, such as NES-QoS flow or NES-flow are also referred to as NES-flow for consistency.

A first implementation includes mapping of an NES class to data radio bearers (access stratum (AS) level) and related procedure. According to this implementation, the NES class that includes the energy cost metric and associated QCIs can be mapped to different DRBs in RAN according to the NES-DRB mapping rules. These data radio bearers may provide differentiated energy saving configurations to UEs by mapping such data radio bearers to the same or different BWPs in a carrier, where the BWPs can be optimized with certain energy saving configurations. The NG-RAN sends data packets with energy awareness using the NES-DRB toward the service requested by a UE.

There is no one-to-one strict relation between NES flows and data radio bearers. Multiple NES flows can be mapped to the same data radio bearer. It is up to service data adaption protocol (SDAP) to establish or release the necessary data radio bearers, such that the NES flows can be mapped to the appropriate data radio bearers. At the access stratum level, the DRB defines the packet treatment on the radio interface (Uu). A DRB serves packets with the same packet forwarding and scheduling treatment. The NES flow to DRB mapping by NG-RAN is based on NES class and the associated NES profile (e.g., NES configuration and energy saving metric). Separate DRBs may be established for NES flows requiring different treatment, or several NES flows belonging to the same PDU session can be multiplexed in the same DRB.

In the uplink, the mapping of NES Flows to DRBs is controlled by NES-DRB mapping rules which can be signaled in two different ways: First is reflective mapping, for each DRB, the UE monitors the NES class of the downlink packets and applies the same mapping in the uplink. That is, for a DRB, the UE maps the uplink packets belonging to the NES flows(s) corresponding to the NES class and PDU session observed in the downlink packets for that DRB. To enable this reflective mapping, the NG-RAN marks downlink packets over Uu with NES class. Second is explicit configuration, where the NES flow to DRB mapping rules can be explicitly signaled by RRC. The UE always applies the latest update of the mapping rules regardless of whether it is performed via reflective mapping or explicit configuration. When an NES flow to DRB mapping rule is updated, the UE sends an end marker on the old bearer.

In the downlink, the NES class is signaled by NG-RAN over Uu for the purpose of reflective mapping and if neither NG-RAN, nor the NAS intends to use reflective mapping for the NES flow(s) carried in a DRB, then no NES class is signaled for that DRB over Uu. In the uplink, NG-RAN can configure the UE to signal the NES class over Uu. Within each PDU session, it is up to NG-RAN how to map multiple NES flows to a DRB. The NG-RAN can map one or more NES flows to the same DRB.

A second implementation includes radio resource configuration to BWP-specific DTX/DRX. For each serving cell of a UE, the network configures at least one DL BWP (i.e., the initial DL BWP). The network may configure the UE with up to four DL BWPs, but for the UE only one DL BWP can be active at a given time. Currently, a bandwidth of a BWP is semi-statically configured, and the bandwidth of the given BWP cannot be dynamically changed. The current BWP framework allows the UEs to be configured with a default BWP and switching to a default BWP based on a timer. Reduction of the frequency resources within a BWP can be achieved via configuration and scheduling at the gNB.

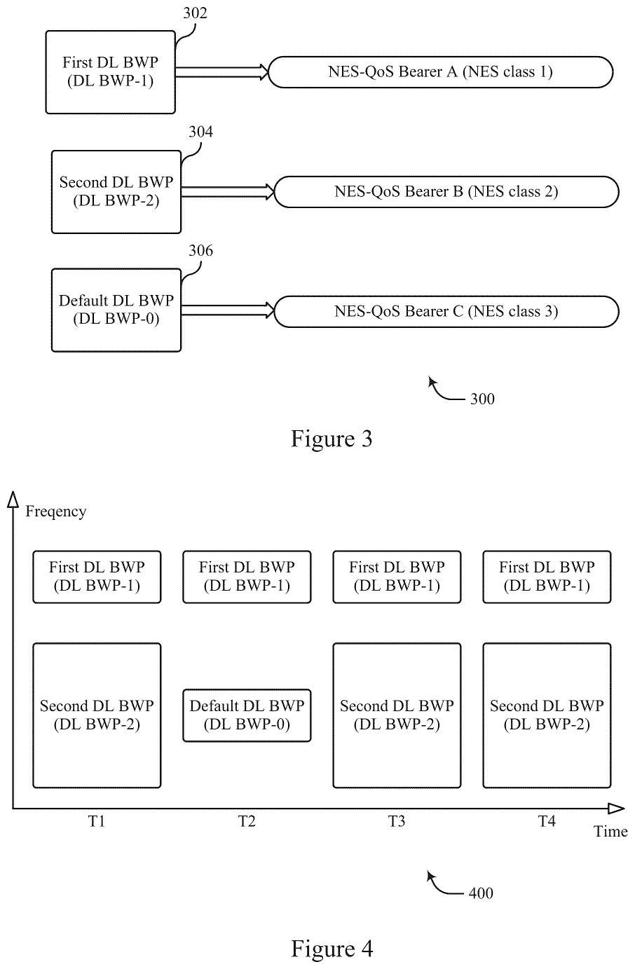

FIG. 3 illustrates an example 300 of an association of an NES-QoS bearer to BWP, in accordance with aspects of the present disclosure. In an implementation, applying the NES class framework to the cell to reduce the cell bandwidth and/or cell load, each bandwidth part may be separately configured with a separate NES configuration, such as BWP-specific DTX/DRX time intervals for sleep (OFF) and awake (ON) time of each BWP. Hence in an implementation, a radio resource configuration can be mapped to one of the multiple bandwidth parts of a serving cell to guarantee corresponding NES class with each BWP. Data radio bearers can be configured in different BWPs considering the target NES class to be achieved. A group-common signaling may be used to indicate the BWP configuration to the UEs.

For example, the network assumes the small DL BWP as the first DL BWP 302 (DL BWP-1) and the large BWP as the second DL BWP 304 (DL BWP-2). A default DL BWP 306 may be configured, otherwise the initial BWP is set to be the default DL BWP (DL BWP-0). As described further, alternatives and respective options represent different possibilities to configure the BWPs with an NES configuration leading to diverse energy savings. Thus, three NES-QoS data radio bearers may be configured, each one associated to a different BWP and thus the NES class depending on the respective BWP configuration.

FIG. 4 illustrates an example BWP baseline 400 (alternative-A), in accordance with aspects of the present disclosure. Labeled as an alternative A, in an implementation, BWPs with different configurations as a baseline from the network perspective are shown in the FIG. 4. Two BWPs (i.e., BWP-1 and BWP-2) are active in time T1. The DL BWP-1 is active all of the time from T1-T4. In time T2, the network may switch the DL BWP-2 to the default DL BWP (DL BWP-0) when there is nothing to transmit or receive in DL BWP-2. In the following time periods T3 and T4, the DL BWP-2 is active again.

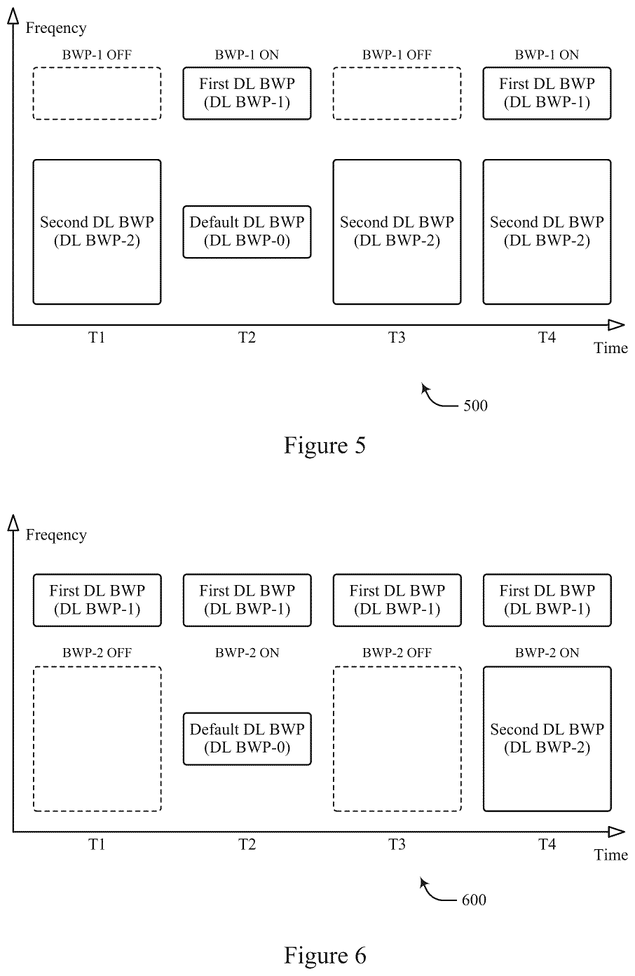

FIG. 5 further illustrates an example of BWPs 500 (alternative A: option A-1), in accordance with aspects of the present disclosure. Labeled as option A-1, and considering alternative A as shown and described with reference to FIG. 4, the DL BWP-1 can be configured with a shorter DTX/DRX on-duration. Following the BWP-specific DTX/DRX configuration, the DL BWP-1 may be turned off during times T1 and T3, and turned on in times T2 and T4. The DL BWP-2 may have a longer DTX/DRX configuration, thus it remains ON in periods T1-T4. This allows for energy saving gains when the BWP-1 is turned OFF.

FIG. 6 illustrates an example of BWPs 600 (alternative A: option A-2), in accordance with aspects of the present disclosure. Labeled as option A-2, and considering option A-1 as shown and described with reference to FIG. 5, the DL BWP-2 can be configured with a shorter DTX/DRX on-duration. Following the BWP-specific DTX/DRX configuration, the DL BWP-2 may be turned off during times T1 and T3, and turned on in times T2 and T4. The DL BWP-1 may have a longer DTX/DRX configuration, thus it remains ON in periods T1-T4. Therefore, more energy saving gains can be expected compared to the baseline and the alternative A, as the larger BWP (BWP-2) is often turned OFF.

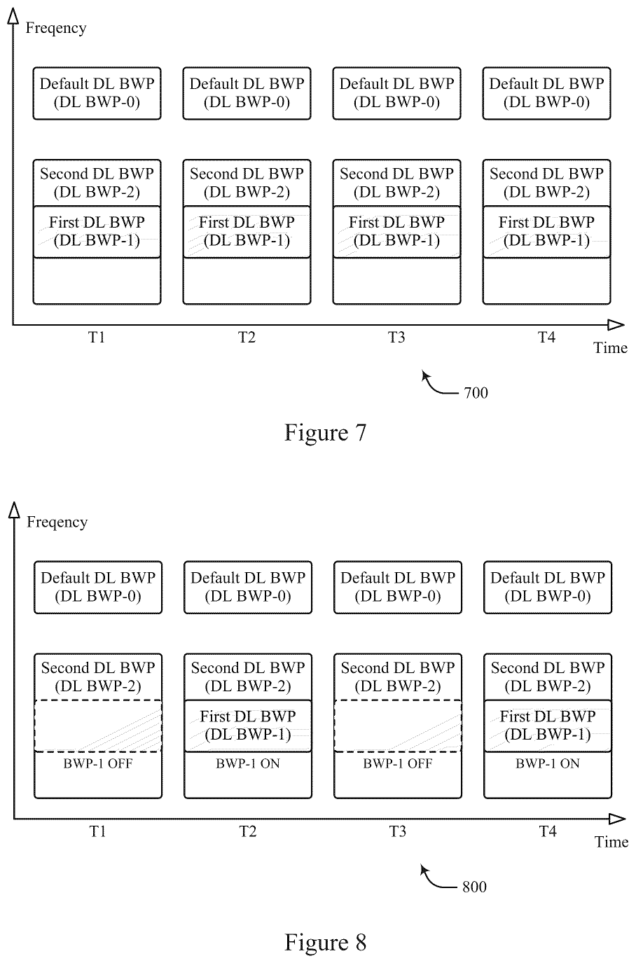

FIG. 7 illustrates an example BWP baseline 700 (alternative-B), in accordance with aspects of the present disclosure. Labeled as alternative B, in another implementation, a different scenario with BWPs is configured as a baseline from the network perspective, as shown in the FIG. 7. Three BWPs are considered, including the default BWP (BWP-0). The two BWPs (i.e., BWP-1 and BWP-2) are overlapping, and both BWP-1 and BWP-2 are active in all time periods T1-T4.

FIG. 8 illustrates an example of BWPs 800 (alternative B: option B-1), in accordance with aspects of the present disclosure. Labeled as option B-1, and considering alternative B as the baseline, the DL BWP-1 can be configured with a shorter DTX/DRX on-duration. Following the BWP-specific DTX/DRX configuration, the DL BWP-1 may be turned off during times T1 and T3, and turned on in times T2 and T4. The DL BWP-2 may have a longer DTX/DRX configuration, thus it remains ON in periods T1-T4. Although the BWP-1 is overlapping with the BWP-2, this allows energy saving to some extent and gains in load balancing as the transmission and/or reception for the UEs on BWP-1 does not take place when the BWP-1 is turned OFF.

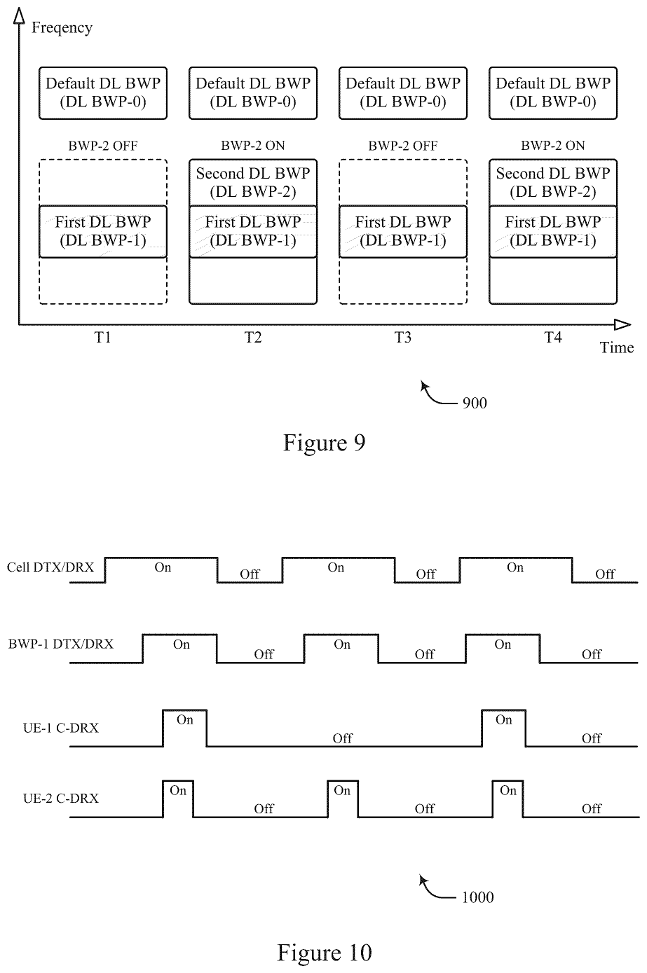

FIG. 9 illustrates an example of BWPs 900 (alternative B: option B-2), in accordance with aspects of the present disclosure. Labeled as option B-2, and considering alternative B as the baseline, the DL BWP-2 can be configured with a shorter DTX/DRX on-duration. Following the BWP-specific DTX/DRX configuration, the DL BWP-2 may be turned off during times T1 and T3, and turned on in times T2 and T4. The DL BWP-1 may have a longer DTX/DRX configuration, thus, it remains ON in periods T1-T4. Therefore, more energy saving gains can be expected compared to the baseline B and alternative B, option B-1, as the larger BWP (BWP-2) is often turned OFF.

FIG. 10 illustrates an example alignment 1000 of a UE C-DRX configuration with BWP and a cell DTX/DRX, in accordance with aspects of the present disclosure. In an implementation for UE behavior for BWP-specific DTX/DRX, the UE C-DRX and the cell DTX/DRX are aligned such that the UE sleep duration has an overlap with the cell DTX/DRX. This ensures that the UE is active, and its reception is ON when the cell is transmitting.

Similar to cell DT/DRX, it is necessary that the BWP DTX/DRX on-duration is an integer multiple of the cell DTX/DRX and the UE C-DRX is an integer multiple of the active BWP-specific DTX/DRX (from the UE perspective). In an implementation, as shown in the FIG. 10, assuming two UEs (i.e., UE-1 and UE-2) are configured with BWP-1. Thus, the network configures BWP-1 with DTX/DRX considering the configuration of cell DTX/DRX and the on-duration of the C-DRX configuration of the UEs must be aligned with the DTX/DRX on-duration of their active BWP. Given bandwidth parts (4 max), the UE is awake and aligned with the cell and the bandwidth part that is operable.

In another implementation for logical channel mapping for uplink data radio bearers, the MAC entity is configured in accordance with the received mac-LogicalChannelConfig. The information element (IE) LogicalChannelConfig can be used to configure the logical channel parameters. The RRC message configures the priorities of the logical channels at three levels (i.e., the logical channel priority, a prioritized bit rate (PBR) in Kilobytes/s, and the bucket size duration as a timer, set for the logical channel. The PBR is configured be the gNB for each logical channel to solve the problem of starvation. In an implementation, when the NES-mode is configured and the NES class is provisioned or determined by the network, certain logical channels may be restricted to transmit data in the UL. The logical channels can be mapped for uplink data radio bearers based on the NES-specific radio resource configuration, such as NES-QoS radio bearers. In an implementation, the logical channel may be prioritized or restricted for energy saving, whereas in another implementation, the logical channels may be restricted or prioritized to fulfill the QoS with best effort energy saving. Therefore, the priorities for a logical channel shall be assigned considering the NES class to be achieved.

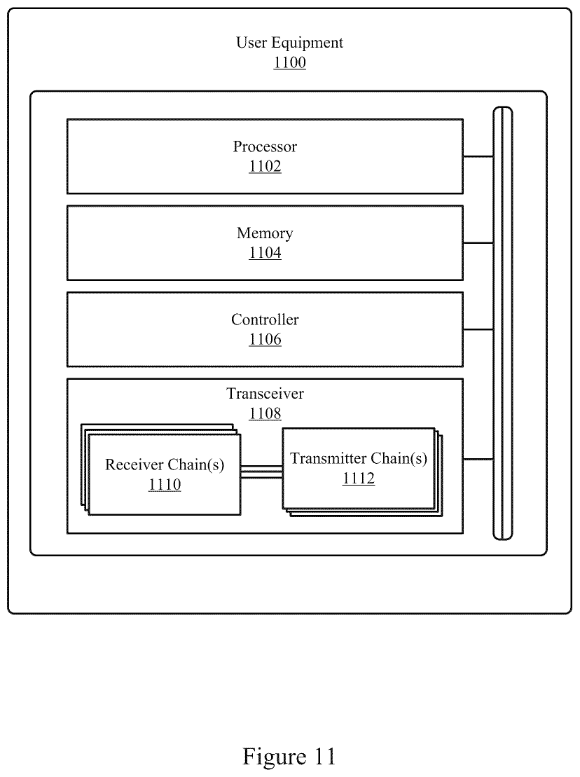

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving, from a NE, a mapping of NES flows to a DRB, the DRB configured at a cell based at least in part on an NES class; and receiving, from the NE, mapping information for an NES DRB configuration to one or more BWPs, the one or more BWPs configured according to at least one NES configuration of the NES class.

Additionally, the UE 1100 may be configured to support any one or combination of the method further comprising causing the UE to align a UE C-DRX with a BWP DTX/DRX and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with a DTX/DRX configuration. The method further comprising receiving the DTX/DRX configuration as part of a group-common signaling of BWP. The method further comprising performing logical channel scheduling as per NES priorities assigned based on the NES DRB configuration when transmitting uplink DRB.

Additionally, or alternatively, the UE 1100 may support at least one memory and at least one processor coupled with the at least one memory and configured to cause the UE to: receive, from a NE, a mapping of NES flows to a DRB, the DRB configured at a cell based at least in part on an NES class; and receive, from the NE, mapping information for an NES DRB configuration to one or more BWPs, the one or more BWPs configured according to at least one NES configuration of the NES class.

Additionally, the UE 1100 may be configured to support any one or combination of the at least one processor is configured to cause the UE to align a UE C-DRX with a BWP DTX/DRX and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with a DTX/DRX configuration. The at least one processor is configured to cause the UE to receive the DTX/DRX configuration as part of a group-common signaling of BWP. The at least one processor is configured to cause the UE to perform logical channel scheduling as per NES priorities assigned based on the NES DRB configuration when transmitting uplink DRB.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

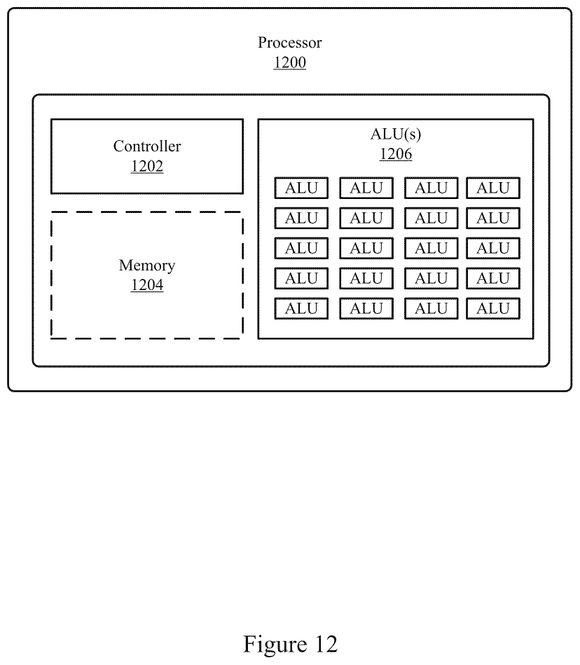

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller coupled with at least one memory and configured to cause the processor to: receive, from a NE, a mapping of NES flows to a DRB, the DRB configured at a cell based at least in part on an NES class; and receive, from the NE, mapping information for an NES DRB configuration to one or more BWPs, the one or more BWPs configured according to at least one NES configuration of the NES class.

Additionally, the processor 1200 may be configured to or operable to support any one or combination of the at least one controller is configured to cause the processor to align a UE C-DRX with a BWP DTX/DRX and with a cell DTX/DRX of the cell. The mapping information includes scheduling restrictions on mapping uplink logical channels according to the NES DRB configuration. The one or more BWPs are configured to include at least one of a cell-specific BWP, a group common BWP, or an NES-specific BWP associated with DTX/DRX configuration. The at least one controller is configured to cause the processor to receive the DTX/DRX configuration as part of a group-common signaling of BWP. The at least one controller is configured to cause the processor to perform logical channel scheduling as per NES priorities assigned based on the NES DRB configuration when transmitting uplink DRB.

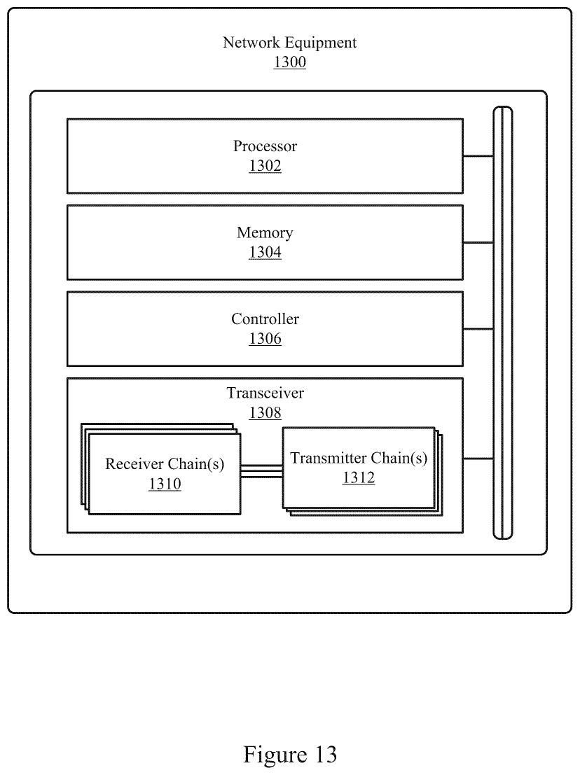

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to or operable to support a means for transmitting, to a UE, a mapping of NES flows to a DRB; configuring the DRB based at least in part on an NES class; configuring one or more BWPs according to at least one NES configuration of the NES class; configuring scheduling restrictions on mapping uplink logical channels according to an NES DRB configuration; associating the DRB to a BWP of the one or more BWPs; and transmitting, to the UE, mapping information for the NES DRB configuration to the one or more BWPs.

Additionally, the NE 1300 may be configured to or operable to support any one or combination of the method further comprising determining the mapping of the NES flows to the DRB in accordance with the NES class. The method further comprising configuring the one or more BWPs comprising at least one of a cell-specific BWP, a group common BWP, or an NES-specific BWP associated with a DTX/DRX configuration. The method further comprising determining the BWP that is associated with the DRB based at least in part on the NES class that is associated to the DRB. A group common signaling of a BWP configuration includes a corresponding NES DTX/DRX configuration of the BWP. The method further comprising configuring a UE C-DRX to partially overlap an on-duration of the BWP that is associated with the DRB and periodicities are an integer multiple. The method further comprising configuring a UE C-DRX so that a periodicity of the NES DTX/DRX configured for the BWP that is associated with the DRB is an integer multiple of the UE C-DRX. The method further comprising configuring an NES DTX/DRX configured for the BWP that is associated with a DRB periodicity to be an integer multiple of the UE C-DRX. The method further comprising configuring an alignment of a UE C-DRX with a BWP DTX/DRX and with a cell DTX/DRX of a cell enabling a partial overlap during an on-duration.

Additionally, or alternatively, the NE 1300 may support at least one memory and at least one processor coupled with the at least one memory and configured to cause the NE to: transmit, to a UE, a mapping of NES flows to a DRB; configure the DRB based at least in part on an NES class; configure one or more BWPs according to at least one NES configuration of the NES class; configure scheduling restrictions on mapping uplink logical channels according to an NES DRB configuration; associate the DRB to a BWP of the one or more BWPs; and transmit, to the UE, mapping information for the NES DRB configuration to the one or more BWPs.

Additionally, the NE 1300 may be configured to support any one or combination of the at least one processor is configured to cause the NE to determine the mapping of the NES flows to the DRB in accordance with the NES class. The at least one processor is configured to cause the NE to configure the one or more BWPs comprising at least one of a cell-specific BWP, a group common BWP, or an NES-specific BWP associated with a DTX/DRX configuration. The at least one processor is configured to cause the NE to determine the BWP that is associated with the DRB based at least in part on the NES class that is associated to the DRB. A group common signaling of a BWP configuration includes a corresponding NES DTX/DRX configuration of the BWP. The at least one processor is configured to cause the NE to configure a UE C-DRX to partially overlap an on-duration of the BWP that is associated with the DRB and periodicities are an integer multiple. The at least one processor is configured to cause the NE to configure a UE C-DRX so that a periodicity of the NES DTX/DRX configured for the BWP that is associated with the DRB is an integer multiple of the UE C-DRX. The at least one processor is configured to cause the NE to configure an NES DTX/DRX configured for the BWP that is associated with a DRB periodicity to be an integer multiple of the UE C-DRX. The at least one processor is configured to cause the NE to configure an alignment of a UE C-DRX with a BWP DTX/DRX and with a cell DTX/DRX of a cell enabling a partial overlap during an on-duration.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

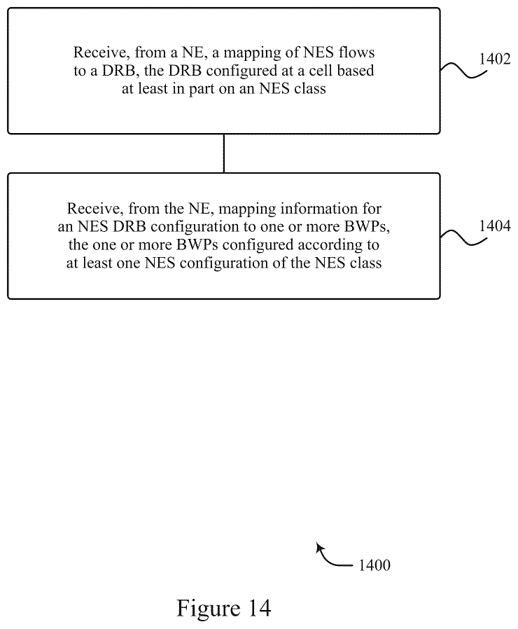

FIG. 14 illustrates a flowchart of a method 1400 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1402, the method may include receiving, from a NE, a mapping of NES flows to a DRB, the DRB configured at a cell based at least in part on an NES class. The operations of 1402 may be performed in accordance with examples as described herein. In some implementations, aspects of the operations of 1402 may be performed by a UE as described with reference to FIG. 11.

At 1404, the method may include receiving, from the NE, mapping information for an NES DRB configuration to one or more BWPs, the one or more BWPs configured according to at least one NES configuration of the NES class. The operations of 1404 may be performed in accordance with examples as described herein. In some implementations, aspects of the operations of 1404 may be performed by a UE as described with reference to FIG. 11.

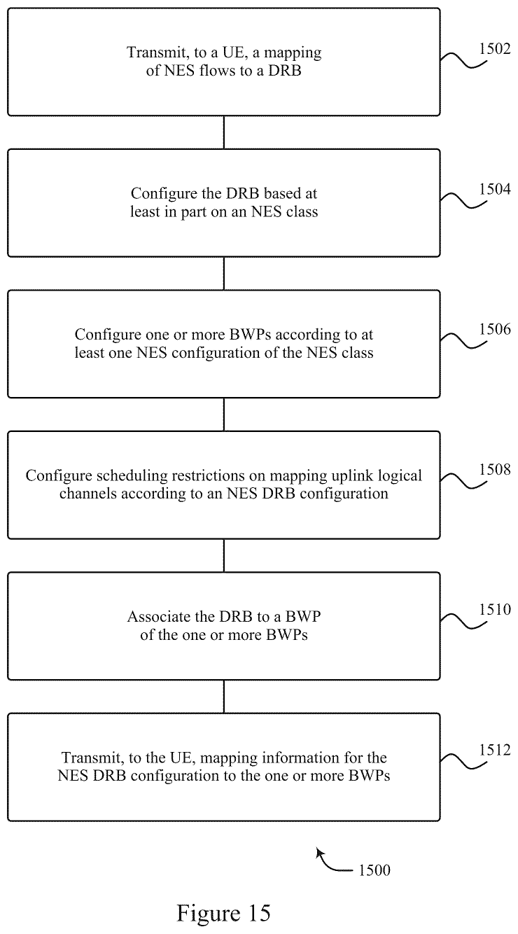

FIG. 15 illustrates a flowchart of a method 1500 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include transmitting, to a UE, a mapping of NES flows to a DRB. The operations of 1502 may be performed in accordance with examples as described herein. In some implementations, aspects of the operations of 1502 may be performed by a NE as described with reference to FIG. 13.

At 1504, the method may include configuring the DRB based at least in part on an NES class. The operations of 1504 may be performed in accordance with examples as described herein. In some implementations, aspects of the operations of 1504 may be performed by a NE as described with reference to FIG. 13.

At 1506, the method may include configuring one or more BWPs according to at least one NES configuration of the NES class. The operations of 1506 may be performed in accordance with examples as described herein. In some implementations, aspects of the operations of 1506 may be performed a NE as described with reference to FIG. 13.

At 1508, the method may include configuring scheduling restrictions on mapping uplink logical channels according to an NES DRB configuration. The operations of 1508 may be performed in accordance with examples as described herein. In some implementations, aspects of the operations of 1508 may be performed a NE as described with reference to FIG. 13.

At 1510, the method may include associating the DRB to a BWP of the one or more BWPs. The operations of 1510 may be performed in accordance with examples as described herein. In some implementations, aspects of the operations of 1510 may be performed a NE as described with reference to FIG. 13.

At 1512, the method may include transmitting, to the UE, mapping information for the NES DRB configuration to the one or more BWPs. The operations of 1512 may be performed in accordance with examples as described herein. In some implementations, aspects of the operations of 1512 may be performed a NE as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity (NE), a mapping of network energy saving (NES) flows to a data radio bearer (DRB), the DRB configured at a cell based at least in part on an NES class; and
receive, from the NE, mapping information for an NES DRB configuration to one or more bandwidth parts (BWPs), the one or more BWPs configured according to at least one NES configuration of the NES class.

2. The UE of claim 1, wherein the at least one processor is configured to cause the UE to align a UE connected-mode discontinuous reception (C-DRX) with a BWP discontinuous transmission and discontinuous reception (DTX/DRX) and with a cell DTX/DRX of the cell.

3. The UE of claim 1, wherein the mapping information includes scheduling restrictions on mapping uplink logical channels according to the NES DRB configuration.

4. The UE of claim 1, wherein the one or more BWPs are configured to include at least one of a cell-specific BWP, a group common BWP, or an NES-specific BWP associated with a discontinuous transmission and discontinuous reception (DTX/DRX) configuration.

5. The UE of claim 4, wherein the at least one processor is configured to cause the UE to receive the DTX/DRX configuration as part of a group-common signaling of BWP.

6. The UE of claim 1, wherein the at least one processor is configured to cause the UE to perform logical channel scheduling as per NES priorities assigned based on the NES DRB configuration when transmitting uplink DRB.

7. A processor for wireless communication, comprising:
at least one controller coupled with at least one memory and configured to cause the processor to:
receive, from a network entity (NE), a mapping of network energy saving (NES) flows to a data radio bearer (DRB), the DRB configured at a cell based at least in part on an NES class; and
receive, from the NE, mapping information for an NES DRB configuration to one or more bandwidth parts (BWPs), the one or more BWPs configured according to at least one NES configuration of the NES class.

8. The processor of claim 7, wherein the at least one controller is configured to cause the processor to align a user equipment (UE) connected-mode discontinuous reception (C-DRX) with a BWP discontinuous transmission and discontinuous reception (DTX/DRX) and with a cell DTX/DRX of the cell.

9. The processor of claim 7, wherein the mapping information includes scheduling restrictions on mapping uplink logical channels according to the NES DRB configuration.

10. The processor of claim 7, wherein the one or more BWPs are configured to include at least one of a cell-specific BWP, a group common BWP, or an NES-specific BWP associated with a discontinuous transmission and discontinuous reception (DTX/DRX) configuration.

11. The processor of claim 10, wherein the at least one controller is configured to cause the processor to receive the DTX/DRX configuration as part of a group-common signaling of BWP.

12. The processor of claim 7, wherein the at least one controller is configured to cause the processor to perform logical channel scheduling as per NES priorities assigned based on the NES DRB configuration when transmitting uplink DRB.

13. A method performed by a user equipment (UE), the method comprising:
receiving, from a network entity (NE), a mapping of network energy saving (NES) flows to a data radio bearer (DRB), the DRB configured at a cell based at least in part on an NES class; and
receiving, from the NE, mapping information for an NES DRB configuration to one or more bandwidth parts (BWPs), the one or more BWPs configured according to at least one NES configuration of the NES class.

14. The method of claim 13, further comprising causing the UE to align a UE connected-mode discontinuous reception (C-DRX) with a BWP discontinuous transmission and discontinuous reception (DTX/DRX) and with a cell DTX/DRX of the cell.

15. The method of claim 13, wherein the mapping information includes scheduling restrictions on mapping uplink logical channels according to the NES DRB configuration.

16. The method of claim 13, wherein the one or more BWPs are configured to include at least one of a cell-specific BWP, a group common BWP, or an NES-specific BWP associated with a discontinuous transmission and discontinuous reception (DTX/DRX) configuration.

17. The method of claim 16, further comprising receiving the DTX/DRX configuration as part of a group-common signaling of BWP.

18. The method of claim 13, further comprising performing logical channel scheduling as per NES priorities assigned based on the NES DRB configuration when transmitting uplink DRB.

19. A network equipment (NE) for wireless communication, comprising:
at least one memory; and
at least one processor coupled with the at least one memory and configured to cause the NE to:
transmit, to a user equipment (UE), a mapping of network energy saving (NES) flows to a data radio bearer (DRB);
configure the DRB based at least in part on an NES class;
configure one or more bandwidth parts (BWPs) according to at least one NES configuration of the NES class;
configure scheduling restrictions on mapping uplink logical channels according to an NES DRB configuration;
associate the DRB to a BWP of the one or more BWPs; and
transmit, to the UE, mapping information for the NES DRB configuration to the one or more BWPs.

20. The NE of claim 19, wherein the at least one processor is configured to cause the NE to determine the mapping of the NES flows to the DRB in accordance with the NES class.
